(19) United States
(12) Patent Application Publication
(10) Pub. No.: US 2004/0234251 A1
(43) Pub. Date: Nov. 25, 2004

(54) Scanner with integrated storage

(76) Inventor: Wei-Chao Kao, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/441,201

(22) Filed: May 20, 2003

(51) Int. Cl. H04N 5/781

(52) U.S. Cl. 386/125; 386/126

(57) ABSTRACT

The invention provides a scanner with integrated storage means, such as a compact disc (CD) writer or digital video disc (DVD) writer. After an image is scanned, it can easily be transferred and saved to the removable storage media such as a compact disc. The images are formatted into a slideshow in VCD format for convenient viewing. The scanned data can easily be viewed on a television connected to the device or since the storage media is removable and portable, moved and viewed in another location. A memory card reader allows images stored on digital camera memory cards to be transferred to CD.

### BACKGROUND OF THE INVENTION

1. Field of the Invention

The present invention relates to a scanner. More specifically, the present invention discloses a scanner with an integrated storage device for converting photographs, slides, and film negatives into a compact disc for archival and viewing.

2. Description of the Prior Art

Traditionally, photographic films cameras have been used to capture images. Once the photographs have been taken the negative film that captured the image, must be taken to a professional developer for processing. Once processed, the images are printed onto photo paper as a final product for the user to view.

However, due to the physical nature and the small size of the printed photograph, viewing by multiple people or sharing of the photograph required multiple copies of the photograph to be made. This is not only inconvenient but also expensive.

Today, image scanners are useful tools for digitizing images. A photograph that has been developed, processed, and printed can be digitized into a computer. However, this method requires an expensive computer hardware and software and scanner setup that is complicated to setup, maintain, and use. Therefore, the majority of people that wish to use this system are unable due to the complexity of it.

Therefore, there is a need for an improved scanner with built-in storage capabilities for conveniently converting photographs, slides, and film negatives into a compact disc for archival and viewing without the need for a computer.

### SUMMARY OF THE INVENTION

To achieve these and other advantages and in order to overcome the disadvantages of the conventional scanner in accordance with the purpose of the invention as embodied and broadly described herein, the present invention provides a standalone scanner with integrated storage.

The present invention is a stand-alone consumer product for converting photographs, slides, and film negatives into a compact disc for archival and viewing. The product provides users with the capability of storing photographs that can be easily shared with others, while being convenient, simple to operate, economical, and produces a broad array of output compatibility, all without the need of a connected computer.

A piece of media, for example a photograph, is placed in the appropriate placement section of the scanning means. By pressing the scan button or selecting the scan function from the menu, the media is scanned. Once the scanning is complete, the data file can be transferred or stored on the removable storage media.

In operation the user places a blank compact disc into the writer and loads the image to be scanned into the scanner. Using the control buttons, the user is able to move through the menu options displayed on the display. When the appropriate function or option is selected, for example, scan image, the function is performed.

The user selects the quality level, either high, fine, or standard quality from the options shown in the display. The user also selects the orientation, for example, scan left 90 degrees, scan right 90 degrees, or scan normal ( no rotation ).

Once the first image is scanned, the scan operations are repeated until all the desired images are scanned and written onto the CD. The finalize command from the options menu is then selected to finalize the CD. After which, the CD may be viewed directly on a television attached to the audio video output of the device or removed from the writer and shared with others.

An advantage of the present invention is that since the CD file format and structure is standard the CD may be played on a standard VCD player. This allows the CD to be shared with and enjoyed by others who may not have the device of the present invention.

The standalone device of the present invention basically comprises a scanning means, a removable storage means, a microprocessor, and memory.

The scanning means comprises, for example, a film, flatbed, or negative scanner. The removable storage means comprises, for example, a CD or DVD writer.

The device of the present invention comprises an embedded system with a built in RISC processor, for example, ARM7. The processor runs a flash booting embedded operating system (OS) and associated control/compression program running from flash ROM.

The scanning means of the device runs under the control of the processor over a parallel command and data link. The scanner provides RGB data first to the SRAM where part of the image is stored temporarily. From here the data is processed by the following operations.

For image files such as, for example JPEG, the image is compressed and written onto the CD-R directly as compressed files at a resolution of, for example 1200 dpi. There are three levels of quality for the user to select—High Quality (HQ), Fine, and Standard. The quality level selection maps to a quality (Q) setting such that the approximate compression ratios are, for example, 8:1, 12:1, and 15:1.

For VCD files, the scanned image is first sub-sampled by a 5×5 to 1 filter kernel to reach CIF reference size. If the user has selected a rotation-inclusive scan, the image is rotated left by 90 degrees or rotated right by 90 degrees. The image is then compressed into a compressed video format, for example, MPEG1 format and stored as individual files in an un-disclosed area of the CD. When the disc is finalized these individual files are chained together and appended with the ISO VCD file structure to create a VCD format disc.

The compact disc can then be played directly from the device of the present invention and viewed on a connected television, or removed from the device and viewed at another location.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing showing a standalone scanner with integrated storage according to an embodiment of the present invention;

FIG. 2 is a block diagram illustrating basic components of a standalone scanner with integrated storage according to an embodiment of the present invention;

FIG. 3 is a drawing showing a standalone scanner with integrated storage according to an embodiment of the present invention;

FIG. 4 is a flowchart illustrating a start up procedure according to an embodiment of the present invention;

FIG. 5 is a flowchart illustrating a ready mode according to an embodiment of the present invention;

FIG. 6 is a flowchart illustrating a change settings mode according to an embodiment of the present invention;

FIG. 7 is a flowchart illustrating a browse mode according to an embodiment of the present invention; and

FIG. 8 is a flowchart illustrating a finalize mode according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

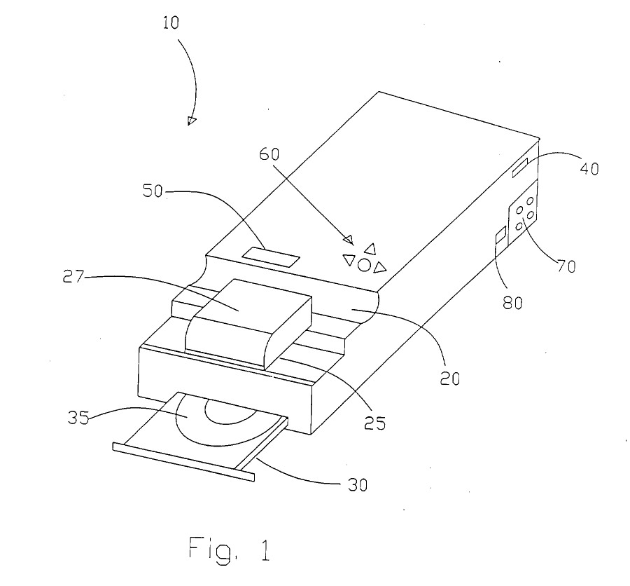

Refer to FIG. 1, which is a drawing showing a standalone scanner with integrated storage according to an embodiment of the present invention.

The scanner with integrated storage 10 in this embodiment comprises a film-type scanner 20, a compact disc writer 30, a display 50, control buttons 60, and audio video output 70.

The film-type scanner 20 further comprises a staging area 25 where the film to be scanned is loaded into the scanner 20.

In operation the user places a blank compact disc 35 into the writer 30 and loads the film to be scanned into the scanner 20. Using the control buttons 60, the user is able to move through the menu options displayed on the display 50. When the appropriate function or option is selected, for example, scan image, the function is performed.

In this example for scanning an image, the user selects the quality level, either high, fine, or standard quality from the options shown in the display. The user also selects the orientation, for example, scan left 90 degrees, scan right 90 degrees, or scan normal ( no rotation).

Once the first image is scanned, the film is moved to the next image either manually or automatically. The scan operations are repeated until all the desired images are scanned and written onto the CD 35. The finalize command from the options menu is then selected to finalize the CD 35. After which, the CD 35 may be viewed directly on a television attached to the audio video output 70 of the device or removed from the writer 30 and shared with others.

An advantage of the present invention is that since the CD file format and structure is standard the CD may be played on a standard VCD player. This allows the CD to be shared with and enjoyed by others who may not have the device of the present invention.

In an embodiment of the present invention, in order to simplify the process, default parameters are used to make the scan and write functions a single button press operation. The user simply loads the film to be scanned into the scanner and presses the scan button and the image is automatically scanned and written to the CD.

Additional options comprise the ability to store the scanned images as single compressed image files or as a video or slideshow. The video or slideshow option further simplifies the process by automatically creating a video or slideshow of the scanned images so that, when viewed, no further image selection is required and a display of the scanned images will automatically transition between images. In this way, once the CD has been created and begins to play, no user intervention is required in order for viewers to enjoy a continuous slideshow of all the images on the CD.

In order to provide conformity for the displayed output, images that are stored on the film in a portrait or landscape orientation may be rotated simply by selecting a rotate right or rotate left option. In this way, images will be stored on the CD in the correct orientation so that during viewing all images will be displayed correctly for the viewers.

A resolution selection is also included in the available options for selecting the quality level of the scanned image. The quality level settings comprise high, fine, and standard quality levels. Depending on the quality level selected, the scanned images are compressed and stored at the appropriate compression ratio. This allows the user to choose between quality and file size or image quantity as desired.

In an embodiment of the present invention, the scanner with integrated storage further comprises a memory card reader 40. The memory card reader 40, for example a reader for smart media, memory stick, secure digital, PCMCIA, and compact flash cards, provides users with the ability to easily transfer photographs taken with a digital camera to a compact disc.

The operation is similar to the above described film scanner procedure except that instead of loading film into the scanner, the memory card is inserted into the memory card reader 40. Following this, the images stored on the memory card are transferred to compact disc.

Also, in other embodiments of the present invention, the device further comprises a USB I/O port 80. This allows the digital camera or device to be connected via USB in order to transfer images from the camera to the device without the need for removing the memory card from the camera. This allows camera's with uncommon memory cards to still be used with the device of the present invention.

In FIG. 1, the memory card interface 40, the audio video outputs 70, and the USB interface 80 are shown on the side of the device. However, the normal positioning of these elements is on the rear.

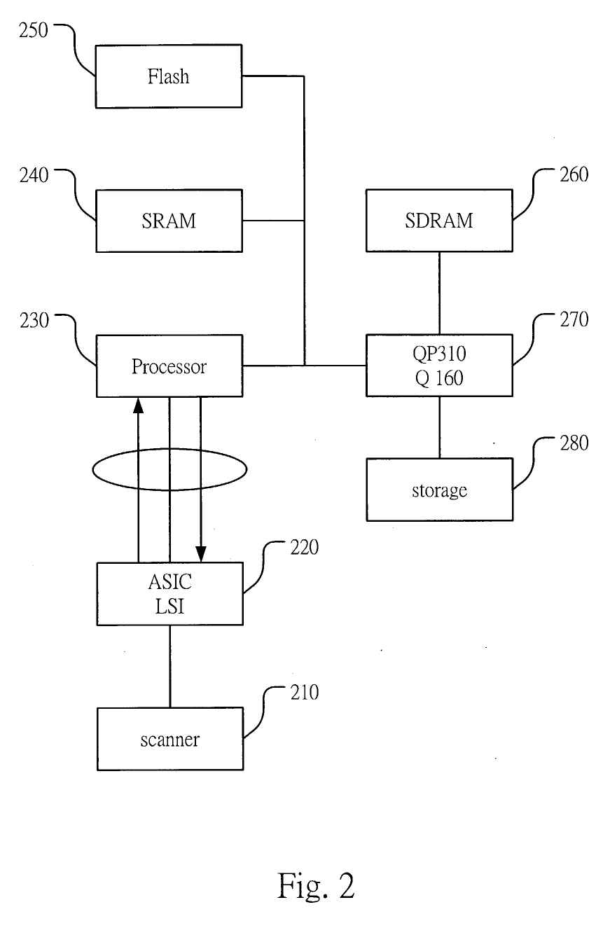

Refer to FIG. 2, which is a block diagram illustrating basic components of a standalone scanner with integrated storage according to an embodiment of the present invention.

The device of the present invention comprises an embedded system with a built in RISC processor 230, for example, ARM7. The processor 230 runs a flash booting embedded operating system (OS) and associated control/compression program running from flash ROM 250.

The scanning means 210 of the device runs under the control of the processor 230 over a parallel command and data link. The scanner provides RGB data first to the SRAM 240 where part of the image is stored temporarily. From here the data is processed by the following operations.

For image files such as, for example JPEG, the image is compressed and written to the storage 280, for example, onto the CD-R directly as compressed files at a resolution of, for example 1200 dpi. There are three levels of quality for the user to select—High Quality (HQ), Fine, and Standard. The quality level selection maps to a quality (Q) setting such that the approximate compression ratios are, for example, 8:1, 12:1, and 15:1.

For VCD files, the scanned image is first sub-sampled by a 5×5 to 1 filter kernel to reach CIF reference size. If the user has selected a rotation-inclusive scan, the image is rotated left by 90 degrees or rotated right by 90 degrees. The image is then compressed into a compressed video format, for example, MPEG1 format and stored as individual files in an undisclosed area of the CD. When the disc is finalized these individual files are chained together and appended with the ISO VCD file structure to create a VCD format disc.

The compact disc can then be played directly from the device of the present invention and viewed on a television connected to the audio video output of the device, or removed from the device and viewed at another location.

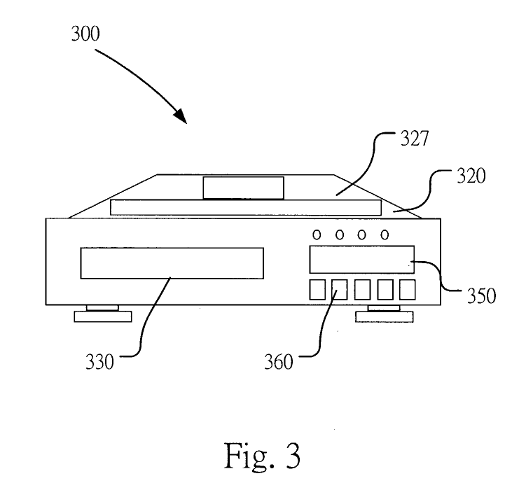

Refer to FIG. 3, which is a drawing showing a standalone scanner with integrated storage according to an embodiment of the present invention.

In an embodiment of the standalone scanner with integrated storage 300 of the present invention, the scanning means comprises a flatbed-type scanner 320. The flatbed-type scanner 320 is suitable for digitizing photographs, drawings, printouts, and documents.

In operation, the cover 327 of the flatbed-type scanner 320 is raised and the image or document to be scanned is placed on the image placement area. The cover 327 is lowered and the image is ready to be scanned. The following operations are performed similarly to the above described film-type scanner procedure.

The operation of the cd writer 330, display 350 and control buttons 360 is as described above. Additionally, the memory card interface, audio video outputs, and USB interface are not shown in FIG. 3. However, in embodiments of the present invention, these elements are included.

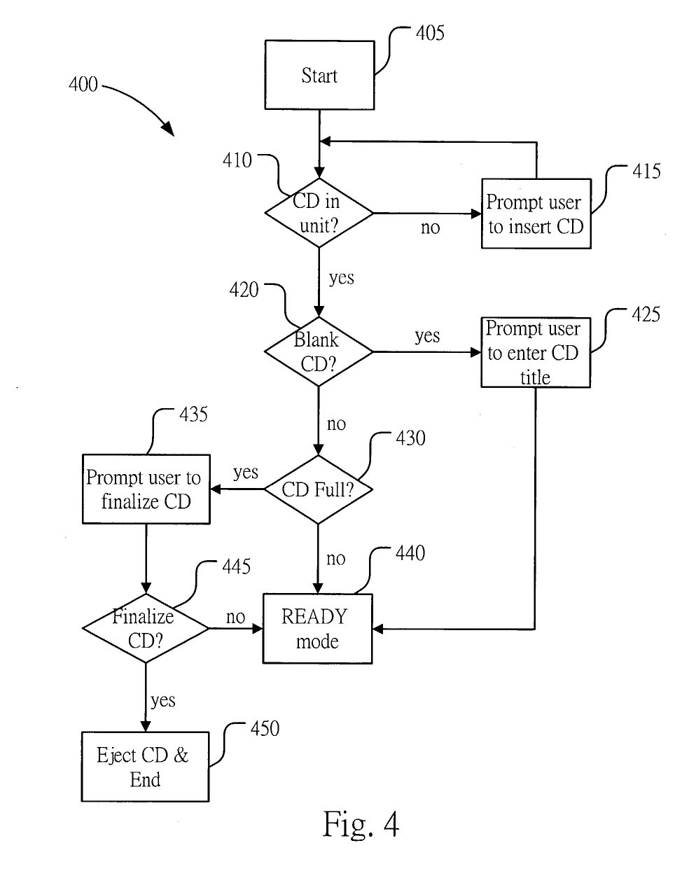

Refer to FIG. 4, which is a flowchart illustrating a start up procedure according to an embodiment of the present invention.

In an embodiment of the present invention as shown in FIG. 4, the start up procedure 400, begins at a start step 405. In step 410, it is determined if a CD is in the unit. If no disc is detected, in step 415, the user is prompted to insert a CD. If a CD is detected, in step 420, it is determined if the CD is a blank CD. If a blank CD is detected, in step 425, the user is prompted to enter a CD title and proceed to step 440. If the detected CD was not a blank CD, in step 430, it is determined if the CD is full. If the CD is not full, proceed to step 440. If the CD is full, in step 435, the user is prompted to finalize the CD. In step 445, if the CD is to be finalized, proceed to step 440. If not, in step 450, the CD is ejected.

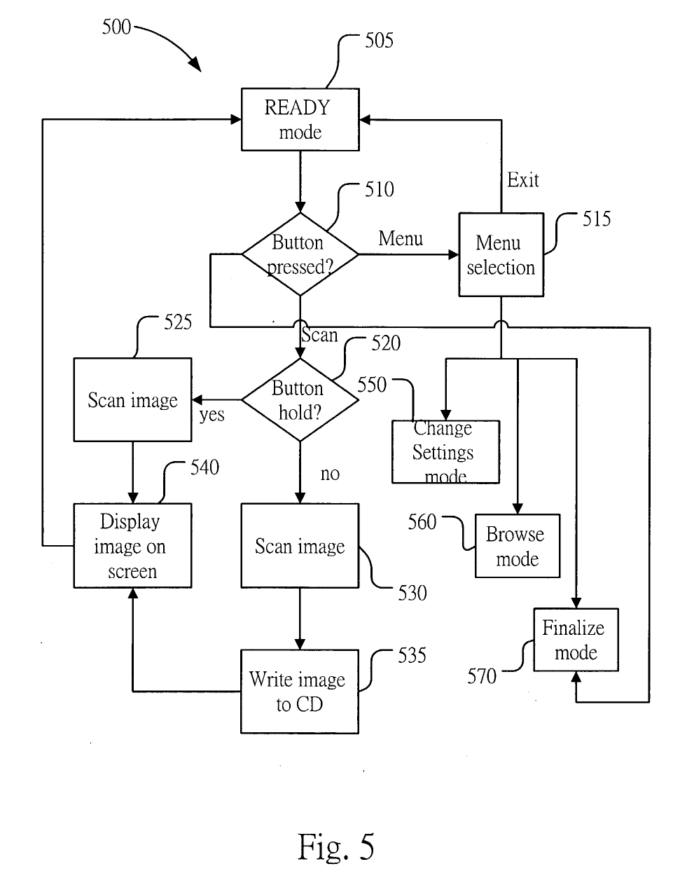

Refer to FIG. 5, which is a flowchart illustrating a ready mode according to an embodiment of the present invention.

In an embodiment of the present invention as shown in FIG. 5, the ready mode procedure 500, begins at a ready mode step 505. In step 510, it is determined if a button is pressed. If the button pressed is finalize, proceed to step 570, finalize mode. If the button pressed is menu, in step 515, if change settings mode is selected, proceed to step 550, if browse mode is selected, proceed to step 560, if finalize mode is selected, proceed to step 570. If the button pressed is scan, in step 520, it is determined if the button is held. If the button is held, in step 525, the image is scanned and in step 540, the image is displayed on the screen, and then proceed to step 505, ready mode. If the button isn't held, in step 530, the image is scanned, in step 535 the image is written to CD, in step 540 the image is displayed on the screen, and proceeds to ready mode, step 505.

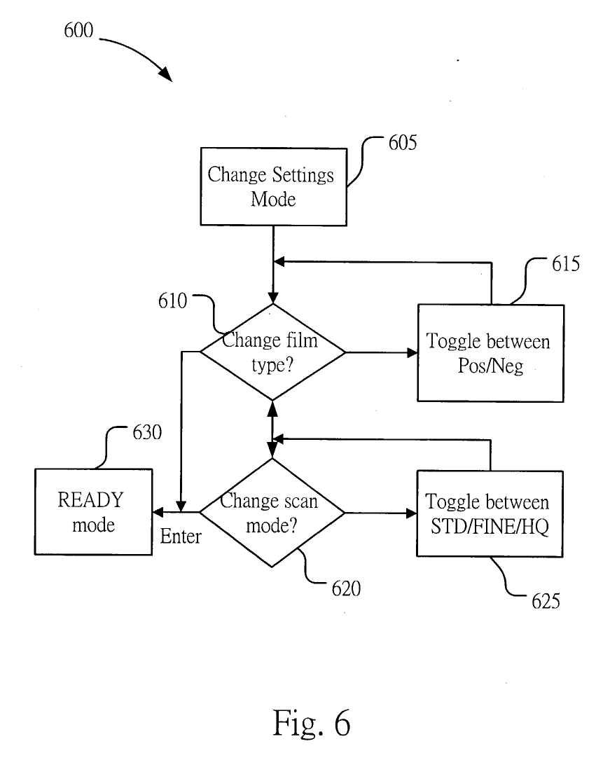

Refer to FIG. 6, which is a flowchart illustrating a change settings mode according to an embodiment of the present invention.

In an embodiment of the present invention as shown in FIG. 6, the change settings mode procedure 600, begins in step 605, change settings. In step 610, it is determined if the film type is to be changed. If yes, in step 615, the type is toggled between negative and positive and returns to step 610. In step 620, it is determined if the scan mode is to be changed. If yes, in step 625, the mode is toggled between standard, fine, and high quality and returns to step 620. If either film type or scan mode are not to be changed, proceed to step 630, ready mode.

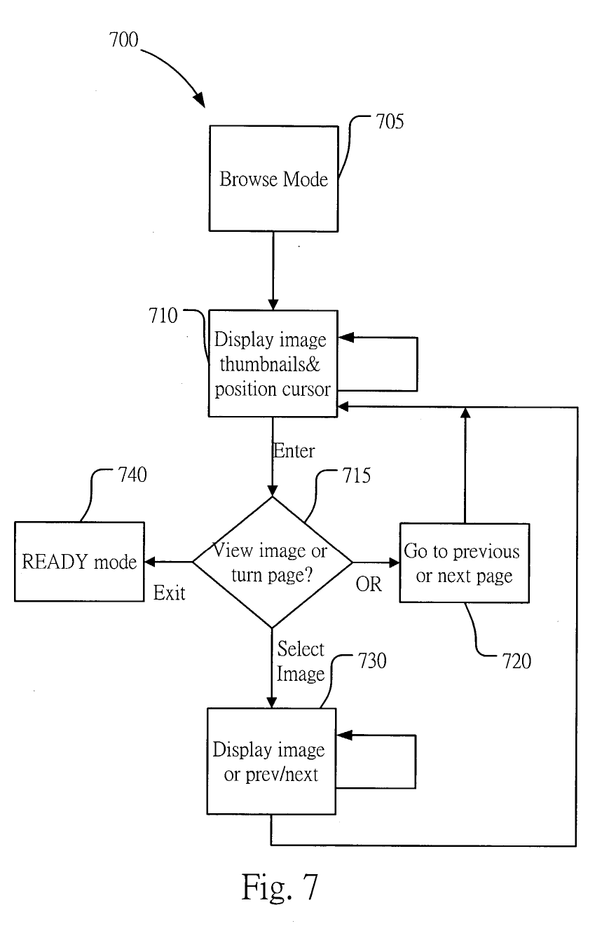

Refer to FIG. 7, which is a flowchart illustrating a browse mode according to an embodiment of the present invention.

In an embodiment of the present invention as shown in FIG. 7, the browse mode procedure 700, begins in step 705, browse. In step 710, the thumbnail images are displayed and the cursor is positioned. Upon entering, in step 715, it is determined if the image is to be viewed or the page turned. If turn page, in step 720, go to the previous or next page and return to step 710. If an image is selected, in step 730, the image is displayed or the previous or next image is displayed. Then return to step 710. Upon exit, proceed to step 740, ready mode.

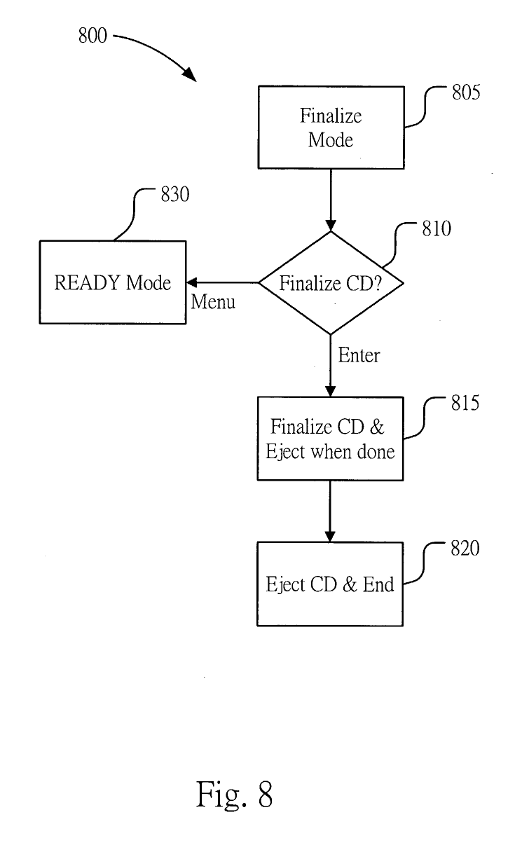

Refer to FIG. 8, which is a flowchart illustrating a finalize mode according to an embodiment of the present invention.

In an embodiment of the present invention as shown in FIG. 8, the finalize mode procedure 800, begins at step 805, finalize mode. In step 810 it is determined if the CD is to be finalized. If not, return to menu and proceed to ready mode, step 830. If yes, in step 815, the CD is finalized and ejected in step 820.

Following is a basic summary for use as an example of some of the various modes and procedures. On power up with no CD inside the unit, the user is prompted to either insert a blank CD or a non-finalized CD. When a blank CD is inserted, the unit enters into setup mode and the user is prompted to enter a CD title. Once finished, the unit enters into ready mode.

Once the CD is set up, the unit enters into ready mode and is ready for scanning. Some of the modes available are: ready, where the unit is ready to scan and write to CD; change settings, where the film type (pos/neg) or scan mode (std/fine/hq) can be changed; browse, where the stored images are displayed; and finalize, where the CD is finalized.

Additionally, an image may be scanned without writing to CD. This feature is to allow the user to test scan a film first without writing it onto the CD. This feature is only useful when connected to a display or TV. To use this feature, one of the scanning buttons is pressed and held until the scanning process begins (approximately 2 seconds). Once scanned, the image will be displayed.

The above described embodiments of the present invention have focused on a compact disc (CD) writer, however, in other embodiments of the present invention the integrated storage device is a digital video disc (DVD) writer. In these embodiments, due to the larger capacity of the DVD, more images may be stored.

Additionally, in other embodiments of the present invention the disc or file format is, for example, DVD, Divx, AVI, Mpeg 4, GIF, PNG, etc.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A standalone scanner with integrated storage comprising:
a scanning means for digitizing an image; and
an integrate storage means for storing the digitized images.

2. The device of claim 1, wherein the scanning means comprises a film-type scanner.

3. The device of claim 1, wherein the integrated storage means comprises a compact disc writer.

4. The device of claim 1, wherein the integrated storage means comprises a digital video disc writer.

5. The device of claim 1, wherein the integrated storage means writes to a removable storage medium.

6. The device of claim 1, further comprising:
a display for displaying options; and
a plurality of control buttons for navigating the options.

7. The device of claim 1, further comprising an audio video output for connection with an external display to view the digitized images.

8. The device of claim 3, further comprising:
a memory card reader for allowing images stored on a memory card, to be transferred to the compact disc writer.

9. The device of claim 1, further comprising:
a universal serial bus connection for allowing data to be transferred from an external device to the integrated storage means.

10. The device of claim 1, wherein the digitized images are stored in a video compact disc format.

11. The device of claim 1, wherein the digitized images are stored in jpeg format.

12. The device of claim 1, wherein the stored digitized images may be viewed as a slideshow or movie.

13. A standalone scanner with integrated storage comprising:
a scanning means for digitizing an image;
an integrate storage means for storing the digitized images;
wherein the integrated storage means writes to a removable storage medium;
a display for displaying options;
a plurality of control buttons for navigating the options;
an audio video output for connection with an external display to view the digitized images;
a memory card reader for allowing images stored on a memory card to be transferred to the integrated storage means; and
a universal serial bus connection for allowing data to be transferred from an external device to the integrated storage means.

14. The device of claim 13, wherein the scanning means comprises a film-type scanner.

15. The device of claim 13, wherein the scanning means comprises a flatbed-type scanner.

16. The device of claim 13, wherein the integrated storage means comprises a compact disc writer.

17. The device of claim 13, wherein the integrated storage means comprises a digital video disc writer.

18. The device of claim 13, wherein the digitized images are stored in a video compact disc format.

19. The device of claim 13, wherein the digitized images are stored in jpeg format.

20. The device of claim 13, wherein the stored digitized images may be viewed as a slideshow or movie.
